(19) United States
(12) Patent Application Publication
(10) Pub. No.: US 2026/0288399 A1
(43) Pub. Date: Sep. 24, 2026

(54) NON-TRANSITORY COMPUTER-READABLE STORAGE MEDIUM STORING CONTROL PROGRAM, INFORMATION PROCESSING APPARATUS, AND CONTROL METHOD

(71) Applicant: SEIKO EPSON CORPORATION, Tokyo (JP)

(72) Inventors: Masatsugu INOUE, Shiojiri (JP); Atsushi YUMOTO, Shiojiri (JP)

(21) Appl. No.: 19/571,641

(22) Filed: Mar. 19, 2026

(30) Foreign Application Priority Data
Mar. 21, 2025 (JP) 2025-047204

(51) Int. Cl. G06F 3/12

(52) U.S. Cl. CPC G06F 3/126; G06F 3/1205

(57) ABSTRACT

First display processing causes a selection screen for selecting any one printer of a virtual printer or a physical printer, to be displayed when a print instruction is accepted from any application. Second display processing causes a setting screen for performing print settings of the selected printer, to be displayed. The first display processing causes the selection screen for displaying a plurality of virtual printers as a single print queue, to be displayed. The second display processing causes the setting screen to be displayed in a state where one virtual printer to be used by the user is selectable from among the plurality of virtual printers.

The present application is based on, and claims priority from JP Application Serial Number 2025-047204, filed Mar. 21, 2025, the disclosure of which is hereby incorporated by reference herein in its entirety.

### BACKGROUND

### 1. Technical Field

The present disclosure relates to a non-transitory computer-readable storage medium storing a control program, an information processing apparatus, and a control method.

### 2. Related Art

There is a technique in which the operating system (OS) provides standard printing functions without requiring a printer-specific printer driver provided by the printer vendor. In a related technique, JP-A-2021-124738 discloses a program of print control software. The technique described in JP-A-2021-124738 registers a virtual printer that supports OS standard printing software related to print queues registered in the print control software.

In the technique described in JP-A-2021-124738, when the user uses the printer, print queues for all the printers including all the registered virtual printers are displayed on the printer selection screen. However, when a large number of virtual printers are registered, the print queues of a large number of virtual printers are displayed on the selection screen. Therefore, when a large number of virtual printers are registered, selecting the print queue for the printer the user wants to use becomes complicated for the user. Therefore, there is a concern that the user cannot efficiently set the print queue.

### SUMMARY

According to an aspect of the present disclosure, there is provided a non-transitory computer-readable storage medium storing a control program for extending a general-purpose printer driver, the control program causing a computer to execute first display processing for displaying a selection screen for selecting any one printer of a virtual printer or a physical printer, when a print instruction is accepted from any application, and second display processing for displaying a setting screen for performing print settings of the selected printer, in which the first display processing causes the selection screen for displaying a plurality of virtual printers as a single print queue, to be displayed, and the second display processing causes the setting screen to be displayed in a state where one virtual printer to be used by the user is selectable from among the plurality of virtual printers.

According to another aspect of the present disclosure, there is provided an information processing apparatus that executes a non-transitory computer-readable storage medium storing a control program for extending a general-purpose printer driver, the apparatus including: a first display processing section configured to display a selection screen for selecting any one printer of a virtual printer or a physical printer, when a print instruction is accepted from any application; and a second display processing section configured to display a setting screen for performing print settings of the selected printer, in which the first display processing section causes the selection screen for displaying a plurality of virtual printers as a single print queue, to be displayed, and the second display processing section causes the setting screen to be displayed in a state where one virtual printer to be used by the user is selectable from among the plurality of virtual printers.

According to still another aspect of the present disclosure, there is provided a control method for executing a non-transitory computer-readable storage medium storing a control program for extending a general-purpose printer driver, the method including: first display processing for displaying a selection screen for selecting any one printer of a virtual printer or a physical printer, when a print instruction is accepted from any application; and second display processing for displaying a setting screen for performing print settings of the selected printer, in which the first display processing causes the selection screen for displaying a plurality of virtual printers as a single print queue, to be displayed, and the second display processing causes the setting screen to be displayed in a state where one virtual printer to be used by the user is selectable from among the plurality of virtual printers.

### BRIEF DESCRIPTION OF THE DRAWINGS

FIG. 1 is a view illustrating a printing system according to Embodiment 1.

FIG. 2 is a view illustrating the printing system according to Embodiment 1.

FIG. 3 is a view illustrating an example of a display screen of print queues for a printer according to Comparative Example.

FIG. 4 is a view illustrating a configuration of an information processing apparatus according to Embodiment 1.

FIG. 5 is a view illustrating a configuration of the information processing apparatus according to Embodiment 1.

FIG. 6 is a view illustrating an example of the display screen of the print queues for the printer according to Embodiment 1.

FIG. 7 is a flowchart illustrating processing executed by the information processing apparatus according to Embodiment 1.

FIG. 8 is a view illustrating an example of a print setting screen according to Comparative Example.

FIG. 9 is a view illustrating an example of the print setting screen according to Comparative Example.

FIG. 10 is a view illustrating an example of the print setting screen according to Embodiment 1.

FIG. 11 is a view illustrating an example of the print setting screen according to Embodiment 1.

FIG. 12 is a view illustrating an example of the print setting screen according to Comparative Example.

FIG. 13 is a view illustrating an example of the print setting screen according to Comparative Example.

FIG. 14 is a view illustrating an example of the print setting screen according to Embodiment 1.

FIG. 15 is a view illustrating an example of the print setting screen according to Embodiment 1.

FIG. 16 is a view illustrating an example of the print setting screen according to Embodiment 1.

FIG. 17 is a view illustrating an example of the print setting screen according to Embodiment 1.

FIG. 18 is a view illustrating an example of the print setting screen according to Embodiment 1.

### DESCRIPTION OF EMBODIMENTS

### Embodiment 1

Hereinafter, the embodiments will be described with reference to the drawings. For clarification of the description, the following description and drawings are appropriately omitted and simplified. In each drawing, the same elements will be given the same reference numerals, and the redundant description thereof will be omitted as necessary.

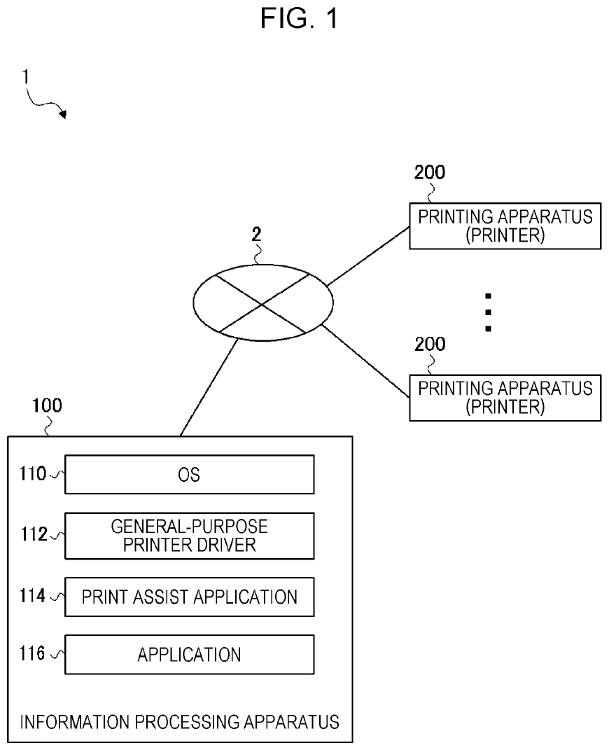

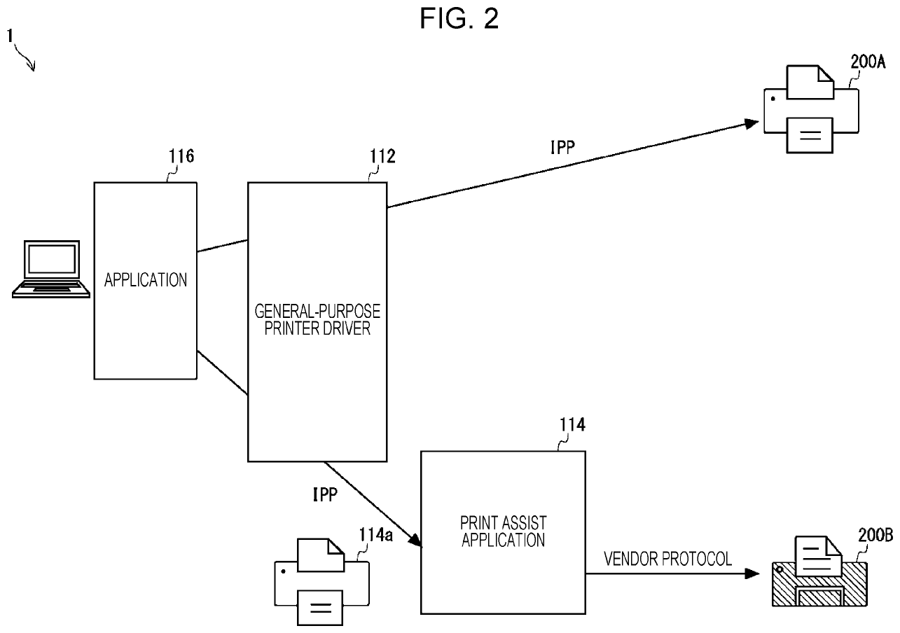

FIGS. 1 and 2 are views illustrating a printing system 1 according to Embodiment 1. The printing system 1 includes an information processing apparatus 100 and one or more printing apparatuses 200. The printing system 1 may include a plurality of information processing apparatuses 100. The information processing apparatus 100 and the printing apparatus 200 are coupled to be able to communicate with each other via a wired or wireless network 2. The network 2 may be, for example, a local area network (LAN) such as a wired LAN or a wireless LAN, or may be the Internet.

The information processing apparatus 100 is a computer including a processor, a memory, and the like. The information processing apparatus 100 operates by an OS which is basic software. The information processing apparatus 100 is, for example, a computer such as a personal computer (PC). The information processing apparatus 100 functions as an information processing terminal. The information processing apparatus 100 may be a portable terminal such as a smartphone or a tablet terminal. The information processing apparatus 100 is a device operated by a user.

When a print request for an image is made by the operation of the user, the information processing apparatus 100 generates a print job corresponding to the print request, and places the generated print job into a print queue corresponding to the printing apparatus 200 that performs printing. The information processing apparatus 100 transmits the print data indicating the print job to the printing apparatus 200 corresponding to the print queue. The information processing apparatus 100 causes the printing apparatus 200 to execute printing by using a general-purpose printer driver 112 and a print assist application 114, which will be described later.

The print data corresponds to a print command generated by the operation of the user or the like. In addition, the print data includes image data to be printed on a print medium such as paper. The image data is, for example, document editing file data, image display file data, or the like. The image data is an image to be printed. Hereinafter, the term “image” also means “image data indicating an image” as a processing target in information processing.

The print queue has a function of sequentially causing the printing apparatus 200 to execute printing while accumulating the print jobs. Further, a print queue is provided for each printer. In the present embodiment, a print queue is provided not only for the physical printer, which is the actual printer, but also for the virtual printer which is the imaginary printer. The physical printer corresponds to a device that actually prints an image on a medium. That is, the physical printer is a printer of an actual machine.

The information processing apparatus 100 includes an OS 110, the general-purpose printer driver 112, the print assist application 114, and an application 116. The OS 110 is basic software. The OS 110 controls the operations of the general-purpose printer driver 112, the print assist application 114, and the application 116.

The general-purpose printer driver 112 is a printer driver that is a standard of the OS. The general-purpose printer driver 112 has an OS standard printing function, which is a function of the OS for providing a standard printing function. The general-purpose printer driver 112 can be a program that can be used to control the printer in a general-purpose manner and execute printing for various types of printers. The general-purpose printer driver 112 may be referred to as an OS general-purpose printing program or a general-purpose printing program. The general-purpose printer driver 112 may execute printing on a printer that supports IPP (Internet Printing Protocol) by using, for example, IPP. IPP is an example of a standard protocol for controlling the management and printing of a printer. The general-purpose printer driver 112 acquires or controls the printer information by a POST request and a response of the Hyper Text Transfer Protocol (HTTP) through communication in accordance with the IPP. The general-purpose printer driver 112 can perform the printer setting and the printer state acquisition by using IPP. The general-purpose printer driver 112 may generate print data in accordance with the IPP and transmit the generated print data to the printing apparatus 200.

The print assist application 114 has a function for extending the general-purpose printer driver 112. That is, the print assist application 114 is an application program that assists the general-purpose printer driver 112. The print assist application 114 may be realized by, for example, a print support application (PSA).

The print assist application 114 is an application program provided by a vendor of the printer or the like. The print assist application 114 may be provided to the user of the information processing apparatus 100 by being published in, for example, an application store provided by the provider of the OS. Alternatively, the print assist application 114 may be included in the OS or provided to the user as an attachment to the OS. The print assist application 114 couples the information processing apparatus 100 to the printing apparatus 200 manufactured by the vendor providing the print assist application 114, and causes the printing apparatus 200 to execute printing.

The print assist application 114 may be a program for assisting the general-purpose printer driver 112 and causing the computer to execute print control suitable for the capabilities of the target printer, that is, print control that supports the unique functions of the printer. The print assist application 114 may convert the print job such that printing using unique functions of the designated printer can be executed on that printer, when the print job is acquired from the general-purpose printer driver 112. The print assist application 114 may convert the print data into print data in accordance with the vendor protocol, which is a protocol supported by the printer corresponding to the print assist application 114. The print assist application 114 may transmit the converted print data to the printing apparatus 200. Further, the print assist application 114 may control the management and printing of the printer by the vendor protocol. The print assist application 114 may acquire or control information of the printer by communication in accordance with the vendor protocol. The print assist application 114 may perform the printer setting and the printer state acquisition by the vendor protocol.

The application 116 is any application software capable of performing processing accompanied by printing. The application 116 may be, for example, document editing software, spreadsheet software, image editing software, or photo display software. The application 116 generates image data to be printed. Further, when the user performs the operation of the print instruction, the application 116 may call the OS standard printing function of the general-purpose printer driver 112. As a result, the general-purpose printer driver 112 can execute printing of the image data generated by the application 116 by using the OS standard printing function.

The printing apparatus 200 is an apparatus that performs printing, for example, a printer or the like. The printing apparatus 200 corresponds to the physical printer described above. The printing apparatus 200 functions as an image forming apparatus that forms an image on a medium. The printing apparatus 200 may have a function as a computer. The printing apparatus 200 may be, for example, a multifunction peripheral (MFP). The printing apparatus 200 accepts print data corresponding to a print job from the information processing apparatus 100 and executes print processing related to the print data. As a result, the printing apparatus 200 performs printing.

Further, the printing apparatus 200 may transmit status information indicating the current status of the printing apparatus 200 to the information processing apparatus 100. The printing apparatus 200 may transmit the status information in response to a request from the information processing apparatus 100. Further, the printing apparatus 200 may periodically transmit the status information to the information processing apparatus 100. The status information may indicate a state of the operation of the printing apparatus 200, such as “printing” or “standby”, for example. Further, for example, the status information may indicate an error state of the printing apparatus 200 such as “out of paper”, “cover is open”, and “no ink remaining”.

Here, the printing apparatus 200 includes a printer that supports the OS standard printing function of the general-purpose printer driver 112 and a printer that does not support the OS standard printing function. As illustrated in FIG. 2, a printing apparatus 200A that supports the OS standard printing function may receive the print data from the information processing apparatus 100 by communication in accordance with, for example, the IPP.

On the other hand, a printing apparatus 200B that does not support the OS standard printing function cannot receive the print data from the information processing apparatus 100 by the communication in accordance with the IPP. That is, the information processing apparatus 100 cannot transmit the print data in accordance with the IPP to the printing apparatus 200B. Therefore, the information processing apparatus 100 cannot cause the printing apparatus 200B to execute printing by the general-purpose printer driver 112.

Therefore, the printing apparatus 200B that does not support the OS standard printing function may receive the print data from the information processing apparatus 100 by communication in accordance with the protocol corresponding to the print assist application 114 provided by the vendor of the printing apparatus 200B. That is, the information processing apparatus 100 may perform communication with the printing apparatus 200B by the print assist application 114 provided by the vendor of the printing apparatus 200B.

It should be noted that the information processing apparatus 100 may also perform communication with the printing apparatus 200A that supports the OS standard printing function by the print assist application 114 provided by the vendor of the printing apparatus 200. As a result, the information processing apparatus 100 can cause the printing apparatus 200A to execute printing by using the unique function of the printing apparatus 200, which is provided in the printing apparatus 200A but cannot be executed by the general-purpose printer driver 112.

When the printing apparatus 200 is caused to execute printing by using the print assist application 114, the information processing apparatus 100 registers a virtual printer corresponding to the printing apparatus 200 in the print assist application 114. For example, the virtual printer 114a corresponding to the printing apparatus 200B is registered in the print assist application 114. The registered virtual printer 114a acts as a printer that supports the general-purpose printer driver 112. Therefore, the general-purpose printer driver 112 performs an operation of regarding the virtual printer 114a as a printer that supports the OS standard printing function. That is, the general-purpose printer driver 112 outputs the print data in accordance with the IPP to the virtual printer 114a. That is, the general-purpose printer driver 112 places the print job into the print queue for the virtual printer 114a. The print assist application 114 converts the print data output to the virtual printer 114a into print data in accordance with the vendor protocol and transmits the print data to the printing apparatus 200B.

Here, a comparative example will be described, such as the technique of the above-described JP-A-2021-124738. When a print request is made by the operation of the user, the application 116 outputs the image data to be printed to the general-purpose printer driver 112. The general-purpose printer driver 112 generates a print job based on the image data and the print setting. The generated print job is placed into a print queue of the OS standard printing function. The print settings can be input by the user in advance on the setting screen provided by the general-purpose printer driver 112. The general-purpose printer driver 112 sequentially processes the print jobs that are placed in the print queue.

Here, in the comparative example, in order to use the print assist application 114 from the application 116, it is necessary to register both the print queue of the OS standard printing function described above and the print queue of the print assist application 114. The print queue in the print assist application 114 is a queue for controlling print data output from the virtual printer. When the print queue is registered in the print assist application 114, the print assist application 114 starts the virtual printer. Thereafter, the print assist application 114 designates the virtual printer to automatically register the print queue in the general-purpose printer driver 112. Then, the list of the registered print queues can be displayed by the function of the general-purpose printer driver 112.

Here, the print queues (virtual printer queue) for the virtual printer defined in advance by the vendor are registered in the print assist application 114 in advance. Further, the print queues for the virtual printer corresponding to all the models of the printer provided by the vendor may be registered in advance by the print assist application 114. There may be a large number of models, such as several hundred, depending on the vendor. In that case, print queues for a large number of virtual printers are registered in the print assist application 114 in advance. In such a case, the list of print queues displayed by the function of the general-purpose printer driver 112 may display print queues of a large number of virtual printers.

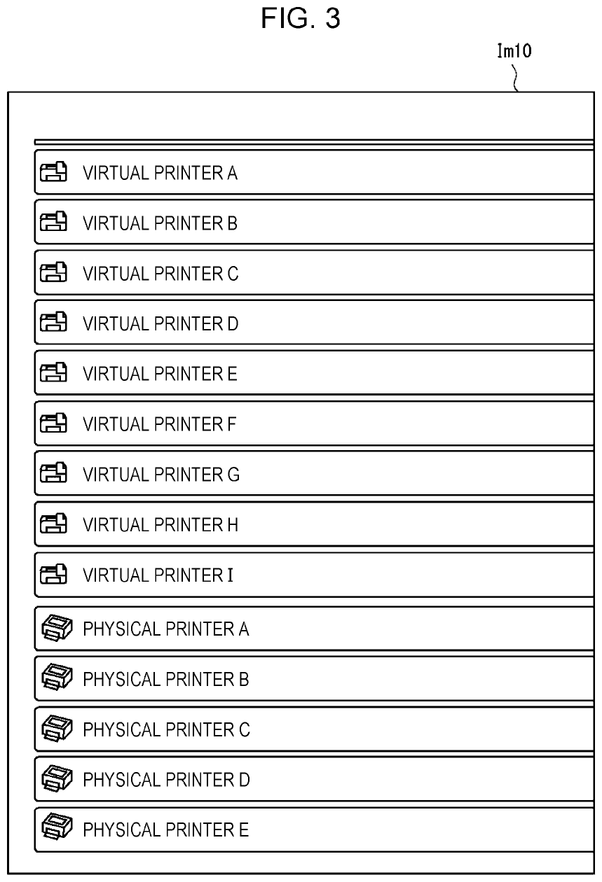

FIG. 3 is a view illustrating an example of a display screen Im10 of the print queues for the printer according to Comparative Example. The display screen Im10 is displayed on the information processing apparatus 100 by, for example, the OS standard printing function of the general-purpose printer driver 112. That is, the display screen Im10 is displayed by the general-purpose printer driver 112. The display screen Im10 displays a list of printers that can be used by the information processing apparatus 100. In the example of FIG. 3, the display screen Im10 displays the print queues of the virtual printers A, B, C, D, E, F, G, H, and I. Further, the display screen Im10 displays the print queues of the physical printers A, B, C, D, and E. As described above, when the print queues of a large number of virtual printers are displayed, it is very complicated for the user to browse the list of printers. Further, when the user wants to perform printing, when the print queues of a large number of virtual printers are displayed on the printer selection screen as illustrated as an example in FIG. 3, it is very complicated for the user to select the print queue for the printer the user wants to use. Therefore, there is a concern that the user cannot efficiently set the print queue.

On the other hand, the printing system 1 according to Embodiment 1 is configured to solve such a problem. Specifically, when the print instruction is accepted from any application, the information processing apparatus 100 executes first display processing for displaying a selection screen for selecting any one printer of the virtual printer or the physical printer. Further, the information processing apparatus 100 executes second display processing for displaying a setting screen for performing print settings of the selected printer. Here, the first display processing causes a selection screen for displaying the plurality of virtual printers as a unified virtual printer queue which is one print queue to be displayed. In addition, the second display processing causes the setting screen to be displayed in a state where one virtual printer used by the user can be selected from among the plurality of virtual printers. With such a configuration, even when a large number of virtual printers are registered in the print assist application 114, the user can easily select the print queue for the printer the user wants to use. Therefore, the user can efficiently set the print queue.

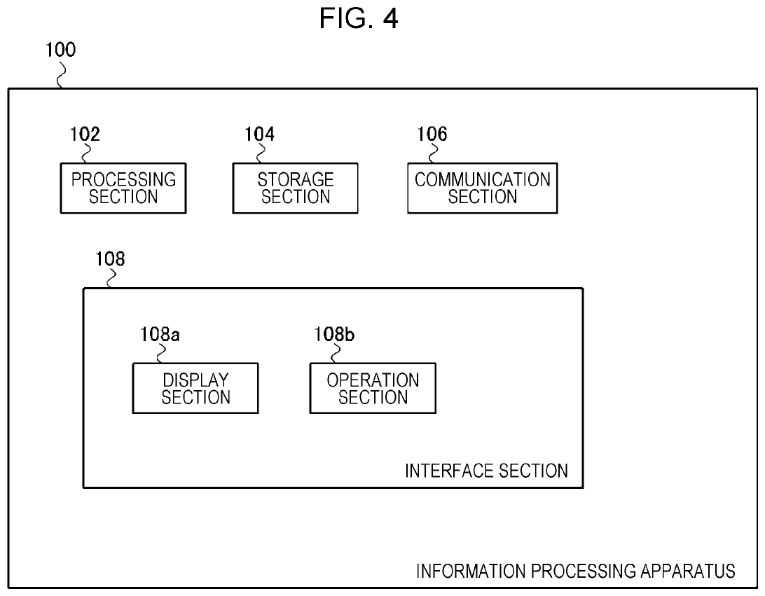

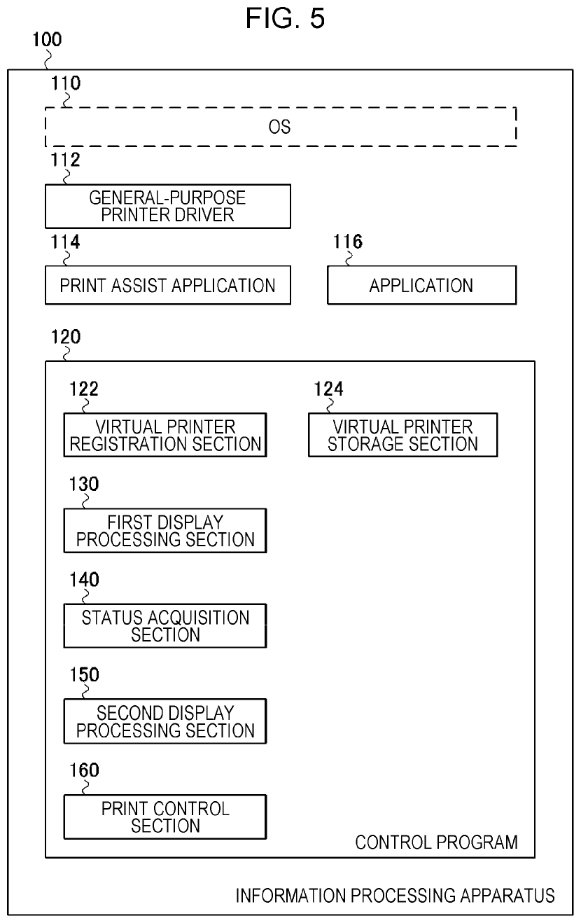

FIGS. 4 and 5 are views illustrating a configuration of the information processing apparatus 100 according to Embodiment 1. FIG. 4 is a view illustrating a hardware configuration of the information processing apparatus 100. The information processing apparatus 100 according to Embodiment 1 has a processing section 102, a storage section 104, a communication section 106, and an interface section 108 as a main hardware configuration. The processing section 102, the storage section 104, the communication section 106, and the interface section 108 may be coupled to each other via a data bus or the like. The printing apparatus 200 may also have the hardware configuration illustrated in FIG. 4.

The processing section 102 is a processor, such as a central processing unit (CPU), for example. The processing section 102 may have a plurality of processors. The processing section 102 has a function as a calculation apparatus that performs control processing, calculation processing, and the like. The processing section 102 controls the storage section 104, the communication section 106, and the interface section 108.

The storage section 104 is a storage device, such as a memory or a hard disk, for example. The storage section 104 is, for example, a read-only memory (ROM) or a random access memory (RAM). The storage section 104 may have a plurality of memories. The storage section 104 has a function of storing a control program, a calculation program, and the like executed by the processing section 102. In addition, the storage section 104 has a function of temporarily storing processing data and the like. The storage section 104 may include a database.

The communication section 106 performs processing necessary for the information processing apparatus 100 to communicate with another apparatus via a network. The communication section 106 can include a communication port, a router, a firewall, and the like. The communication section 106 may perform processing for the information processing apparatus 100 to communicate with the printing apparatus 200. The communication section 106 may perform processing for communication with the printing apparatus 200 by communication in accordance with a protocol (IPP, vendor protocol, or the like) required for communication with the printing apparatus 200.

The interface section 108 is, for example, a user interface. The interface section 108 accepts an operation of the user of the information processing apparatus 100 to input data, and outputs information to the user. The interface section 108 includes a display section 108a and an operation section 108b. The display section 108a is a display device that displays an image, such as a display, for example. The display section 108a is an output apparatus that outputs information. The operation section 108b is, for example, an input device for inputting or selecting information such as a keyboard or a mouse. The operation section 108b is an input apparatus that inputs information. The interface section 108 may be configured such that an input apparatus and an output apparatus are integrated, for example, as in a touch screen or a touch panel. In this case, the display section 108a and the operation section 108b may be actually integrated. In addition, the interface section 108 may have a speaker and a microphone.

FIG. 5 is a view illustrating components of the information processing apparatus 100 according to Embodiment 1. The information processing apparatus 100 according to Embodiment 1 includes the OS 110, the general-purpose printer driver 112, the print assist application 114, and the application 116 as the components described above. Further, the information processing apparatus 100 includes a control program 120 as a component. As components, the control program 120 includes a virtual printer registration section 122, a virtual printer storage section 124, a first display processing section 130, a status acquisition section 140, a second display processing section 150, and a print control section 160. Each component of the control program 120 may be operated by the OS 110 which is the basic software.

Each of the above-described components can be realized by, for example, executing a program under the control of the processing section 102. More specifically, each component can be realized by the processing section 102 executing a program stored in the storage section 104. In addition, the necessary program may be recorded on any non-volatile recording medium and installed as necessary to realize each component.

In addition, each component may be realized by a combination of hardware, firmware, and software, without being limited to being realized by software according to a program. In addition, each component may be realized by using an integrated circuit, which is programmable by a user, such as a field-programmable gate array (FPGA) or a microcomputer, for example. In this case, a program configured to include each of the above-described components may be realized by using the integrated circuit.

The control program 120 controls the printing apparatus 200 to execute printing. The control program 120 performs the above-described first display processing and second display processing. The control program 120 may be realized by the print assist application 114. That is, the control program 120 may be realized by PSA.

The virtual printer registration section 122 performs registration processing for registering the virtual printer in the print assist application 114. In other words, the virtual printer registration section 122 performs registration processing for registering the virtual printer in the control program 120. The virtual printer registration section 122 registers a virtual printer related to a printer (printing apparatus 200) for which execution of printing using the virtual printer is required by the print assist application 114. The virtual printer registration section 122 registers a virtual printer related to a printer that does not support the OS standard printing function of the general-purpose printer driver 112. For example, in the example of FIG. 2, the virtual printer registration section 122 registers the virtual printer 114a related to the printing apparatus 200B. In addition, the virtual printer registration section 122 may register a virtual printer related to a printer (printing apparatus 200) having a function of supporting the OS standard printing function but not executable by the OS standard printing function.

The virtual printer registration section 122 registers a virtual printer related to a printer of a model that can be used by the user. The virtual printer registration section 122 may register a virtual printer related to the printing apparatus 200 coupled to be able to communicate with the information processing apparatus 100, for example. In this case, the virtual printer registration section 122 may register the virtual printer corresponding to the printing apparatus 200 by registering the model information of the printing apparatus 200 coupled to the information processing apparatus 100. In this case, the virtual printer registration section 122 may acquire the model information from the printing apparatus 200 coupled to the information processing apparatus 100, for example. In addition, the virtual printer registration section 122 may register the information on the print settings that can be set in the printing apparatus 200 together with the corresponding virtual printer, in accordance with the acquired model information. For example, when the printing apparatus 200 can perform printing in A3 size, the virtual printer registration section 122 may register that the A3 size printing can be set when registering the virtual printer corresponding to the printing apparatus 200. In addition, for example, when color printing is possible in a certain printing apparatus 200, the virtual printer registration section 122 may register that color printing can be set when registering the virtual printer corresponding to the printing apparatus 200.

Further, the virtual printer registration section 122 may register the virtual printer by selecting the virtual printer related to the printing apparatus 200 coupled to the information processing apparatus 100 from the plurality of virtual printers registered in advance in the print assist application 114. In addition, the virtual printer registration section 122 may register the virtual printer by acquiring the virtual printer related to the printing apparatus 200 coupled to the information processing apparatus 100 from a database in which the model of the printer and the virtual printer are associated with each other, such as a server. Further, the virtual printer registration section 122 may register the virtual printer when the user operates the operation section 108b. Further, the user may set the display name of the virtual printer to be registered in any manner by operating the operation section 108b.

Here, in Embodiment 1, the virtual printer related to the printer of the model that can be used by the user is a virtual printer to be registered as one unified virtual printer queue. That is, the virtual printer registration section 122 registers the virtual printer to be registered as the unified virtual printer queue. Therefore, the virtual printer registered by the virtual printer registration section 122 is collectively displayed as one “unified virtual printer queue” in the first display processing described later. In addition, the print queue for the virtual printers registered by the virtual printer registration section 122 is displayed such that the user can select the print queues in the second display processing described later.

Further, the virtual printer registration section 122 registers the unified virtual printer queue in the OS standard printing function of the general-purpose printer driver 112. Specifically, the virtual printer registration section 122 performs processing such that the unified virtual printer queue is included in the print queue in the OS standard printing function. In other words, the virtual printer registration section 122 performs processing such that one unified virtual printer queue is displayed instead of the print queues for the plurality of virtual printers, in the print queue of the OS standard printing function. The virtual printer registration section 122 may perform processing such that the unified virtual printer queue is displayed in the list of print queues of the printer displayed by the OS standard printing function. Further, the virtual printer registration section 122 may perform processing such that the printer selection screen displays the unified virtual printer queue when a print instruction is performed by any application 116 and the OS standard printing function is called. In this case, the virtual printer registration section 122 may associate the print assist application 114 with the OS standard printing function such that the unified virtual printer queue is displayed on the printer selection screen in any application 116. For example, the virtual printer registration section 122 may perform processing such that the print assist application 114 behaves as a “unified virtual printer queue” printer with respect to the OS standard printing function.

The virtual printer storage section 124 stores the virtual printer registered by the registration processing of the virtual printer registration section 122. The virtual printer storage section 124 can be realized by the storage section 104. The virtual printer storage section 124 may store the virtual printer and the print settings that can be set by the virtual printer in association with each other. On the list display screen of the printer displayed by the OS standard printing function, the print queues of the individual virtual printers registered by the virtual printer storage section 124 are not displayed, and are displayed as one unified virtual printer queue. Similarly, the print queues for the individual virtual printer registered by the virtual printer storage section 124 are not displayed on the printer selection screen displayed in association with the print instruction by the application 116, and are displayed as a unified virtual printer queue.

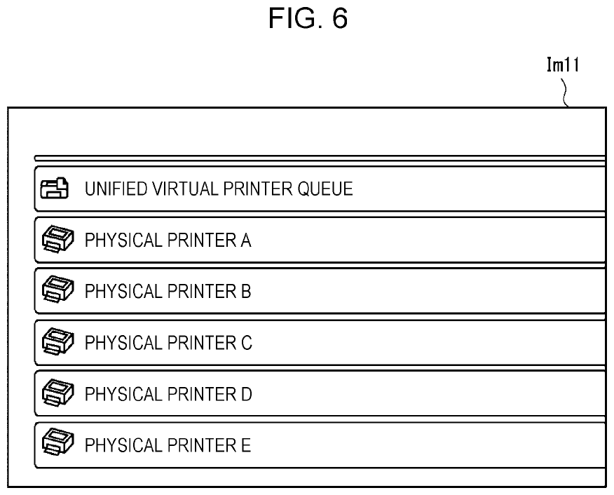

FIG. 6 is a view illustrating an example of a display screen Im11 of the print queues for the printers according to Embodiment 1. The display screen Im11 is displayed on the display section 108a of the information processing apparatus 100 by, for example, the OS standard printing function of the general-purpose printer driver 112. The display screen Im11 is displayed by the general-purpose printer driver 112. The display screen Im11 may be displayed by the first display processing section 130 described later. FIG. 6 corresponds to the display screen Im10 illustrated as an example in FIG. 3, which is improved. In the example of FIG. 6, the display screen Im11 displays one “unified virtual printer queue” instead of the print queues of the virtual printers A, B, C, D, E, F, G, H, and I displayed on the display screen Im10 illustrated as an example in FIG. 3. Further, the display screen Im11 displays the print queues of the physical printers A, B, C, D, and E.

As described above, since the display screen Im11 according to Embodiment 1 displays the print queues for the virtual printers as one unified virtual printer queue, it is possible to suppress the complication when the user browses the printer. In Embodiment 1, the print queues for the virtual printers are also displayed as one unified virtual printer queue on a selection screen of the printer to be described later, as in the example of the display screen Im11. Therefore, it is possible to suppress the complication when the user selects the printer to be used for printing.

The first display processing section 130 performs the first display processing described above. The first display processing section 130 causes a selection screen for selecting a printer to be displayed on the display section 108a. When the print instruction is accepted from any application 116, the first display processing section 130 causes a selection screen for selecting any one printer of the virtual printer or the physical printer to be displayed. The first display processing section 130 causes the selection screen to be displayed such that the plurality of virtual printers are displayed as a unified virtual printer queue, which is a single print queue. The selection screen displayed by the first display processing section 130 displays one unified virtual printer queue and one or more print queues for the physical printers. The first display processing section 130 accepts a selection operation of the user on the selection screen. The user performs a selection operation on the selection screen using the operation section 108b. An example of a printer selection screen will be described later.

The first display processing section 130 may cause a printer selection screen to be displayed by the OS standard printing function of the general-purpose printer driver 112. In this case, the first display processing section 130 may perform processing such that the print queues for the plurality of virtual printers are displayed as one unified virtual printer queue on the selection screen displayed by the OS standard printing function, with respect to the general-purpose printer driver 112. Further, the first display processing section 130 may cause a printer selection screen to be displayed on a screen for performing print settings by the application 116 that gives a print instruction. In this case, the first display processing section 130 may perform processing such that the unified virtual printer queue is displayed on a printer selection screen displayed on a screen for performing print settings of the application 116, with respect to the general-purpose printer driver 112.

The status acquisition section 140 acquires the status information of the printing apparatus 200 from the printing apparatus 200 which is the physical printer. The status acquisition section 140 may transmit a command to the printing apparatus 200 requesting that status information be transmitted to the information processing apparatus 100. The printing apparatus 200 may transmit the status information to the information processing apparatus 100 in response to the request. The status acquisition section 140 may be realized by the communication section 106.

The second display processing section 150 performs the second display processing described above. The second display processing section 150 causes a print setting screen, which is a setting screen for performing print setting for the selected printer, to be displayed on the display section 108a. The second display processing section 150 may cause the print setting screen to be displayed by the function of the print assist application 114. That is, the print settings on the print setting screen displayed by the second display processing section 150 can be performed by the print assist application 114. The second display processing section 150 may cause a print setting screen to be displayed as, for example, a print dialog box.

The second display processing section 150 causes the print setting screen to be displayed when the print queue for the printer is selected on the printer selection screen displayed by the first display processing section 130. The second display processing section 150 causes the print setting screen to be displayed in a state where one virtual printer used by the user can be selected from among the plurality of virtual printers. Here, the second display processing section 150 causes the print setting screen that displays print queues of a plurality of virtual printers to be displayed when the unified virtual printer queue is selected in the printer selection screen displayed by the first display processing. In other words, the second display processing section 150 causes the print setting screen for displaying the print queues for the plurality of virtual printers such that any one of the plurality of virtual printers can be selected, to be displayed when the unified virtual printer queue is selected. The user performs a setting operation on the print setting screen and a selection operation of the virtual printer by using the operation section 108b. As a result, the second display processing section 150 accepts the setting operation and selection operation of the user on the print setting screen. An example of the print setting screen will be described later.

The second display processing section 150 may display the print setting screen for displaying the print queues for the plurality of virtual printers registered by the virtual printer registration section 122. As a result, the user can select a virtual printer the user wants to use, from the plurality of virtual printers registered by the virtual printer registration section 122 by performing a selection operation on the print setting screen. In other words, the user can select the virtual printer corresponding to the printing apparatus 200, on which printing is to be executed, from the plurality of virtual printers registered by the virtual printer registration section 122 by performing a selection operation on the print setting screen.

As described above, the print assist application 114 may be registered in advance with a virtual printer related to all models of printers provided by the vendor providing the print assist application 114. On the other hand, the virtual printer related to the printer of the model that the user cannot use, that is, the model that the user does not own, is highly likely to be unnecessary for the user. Therefore, by displaying the print queues of the virtual printer registered in advance by the virtual printer registration section 122 on the setting screen, the user can efficiently select the used virtual printer. Therefore, the print queues can be set efficiently.

The print setting screen displayed by the second display processing section 150 displays, as the print settings, items for performing various settings in addition to the items for selecting the virtual printer the user wants to use, as described above. The print setting screen may display items for setting, for example, a paper size, single-sided/double-sided printing, color/monochrome printing, and the like.

In addition, the second display processing section 150 may also cause the print setting screen for displaying a selectable virtual printer that can be used, based on print settings other than the selection of the virtual printer, to be displayed. That is, the second display processing section 150 may narrow down and display the print queues for the virtual printer based on the print settings other than the selection of the virtual printer, on the print setting screen. For example, on the print setting screen, when the paper size is set to “A3 size”, the second display processing section 150 may cause only the selectable virtual printer corresponding to the physical printer capable of A3 size printing, to be displayed on the print setting screen. For example, when “color printing” is set on the print setting screen, the second display processing section 150 may cause only the virtual printer corresponding to the selectable physical printer capable of color printing, to be displayed on the print setting screen. With such a configuration, the user can efficiently select only the usable printer when selecting the printer on the print setting screen. In addition, the OS standard printing function does not have a function of narrowing down the display of the virtual printer displayed according to the print setting. Therefore, with the above configuration, it is possible to exhibit the function of narrowing down the display of the virtual printer, which is a function specific to the print assist application 114.

In addition, the second display processing section 150 may cause the print setting screen for displaying a selectable virtual printer that can be used based on the status of the physical printer corresponding to the virtual printer, to be displayed. That is, the second display processing section 150 may narrow down and display the print queues for the virtual printer based on the status of the physical printer corresponding to the virtual printer, on the print setting screen. For example, when the status acquisition section 140 acquires the status information indicating an error such as “out of paper” from a certain printing apparatus 200, the second display processing section 150 may not cause the virtual printer corresponding to the printing apparatus 200 to be displayed on the print setting screen. That is, the second display processing section 150 may cause a selectable virtual printer corresponding to the physical printer other than the printing apparatus 200, to be displayed on the print setting screen. With such a configuration, the user can efficiently select only the usable printer when selecting the printer on the print setting screen. In addition, the OS standard printing function does not have a function of restricting the display of the print queues for the printer according to the printer status. Therefore, with the above configuration, it is possible to exhibit the function of narrowing down the display of the virtual printer, which is a function specific to the print assist application 114.

The print control section 160 executes printing according to the print settings set by the user by using the print setting screen displayed by the second display processing section 150. That is, the print control section 160 executes printing by using the virtual printer selected by the user by using the print setting screen displayed by the second display processing section 150. Specifically, the print control section 160 gives an instruction to execute printing to the physical printer corresponding to the selected virtual printer by using the print settings set by the print assist application 114 by the OS standard printing function by the general-purpose printer driver 112. The print control section 160 transmits the print data to the printing apparatus 200. The print control section 160 controls the communication section 106 to transmit the print data to the printing apparatus 200.

More specifically, the print job to be printed is placed into the print queues for the selected virtual printer by the general-purpose printer driver 112. As a result, the print control section 160 acquires the print data in accordance with the IPP, which is output from the general-purpose printer driver 112 to the selected virtual printer. The print control section 160 converts the print data in accordance with the IPP into the print data in accordance with the vendor protocol corresponding to the virtual printer. The print control section 160 transmits the print data in accordance with the vendor protocol to the printing apparatus 200 corresponding to the virtual printer by the communication of the vendor protocol. As a result, the printing apparatus 200 corresponding to the virtual printer selected on the print setting screen executes printing of the image data indicated by the print data in the print setting set on the print setting screen.

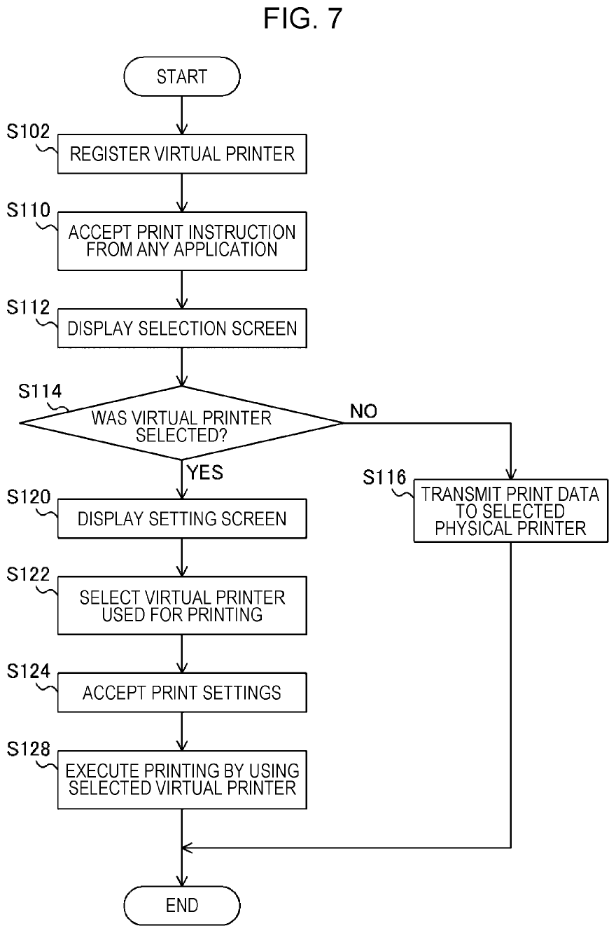

FIG. 7 is a flowchart illustrating processing executed by the information processing apparatus 100 according to Embodiment 1. The flowchart illustrated in FIG. 7 illustrates a control method executed by the information processing apparatus 100 according to Embodiment 1.

The information processing apparatus 100 registers a virtual printer (step S102). The processing of S102 is performed in advance before the execution of printing. As described above, the virtual printer registration section 122 registers the virtual printer in the print assist application 114. Further, the virtual printer registration section 122 registers the virtual printer to be registered in the print assist application 114 as a unified virtual printer queue. That is, the virtual printer registration section 122 performs processing such that the virtual printer is displayed as a unified virtual printer queue in the OS standard printing function of the general-purpose printer driver 112.

The information processing apparatus 100 accepts a print instruction from any application 116 (step S110). As a result, the application 116 calls the OS standard printing function of the general-purpose printer driver 112. At this time, the general-purpose printer driver 112 accepts the image data to be printed from the application 116.

The information processing apparatus 100 displays a printer selection screen (step S112). Specifically, the first display processing section 130 performs the first display processing to cause the selection screen of the printer to be displayed on the display section 108a. As described above, on the printer selection screen, the print queues for each individual virtual printer are not displayed, and one unified virtual printer queue is displayed.

The information processing apparatus 100 determines whether the user selected the virtual printer (step S114). Specifically, the first display processing section 130 determines whether the user selected the unified virtual printer queue or a physical printer, with respect to the printer selection screen. When the user does not select the virtual printer (NO in S114), it is determined that the user selected the physical printer. In this case, the information processing apparatus 100 transmits the print data to the selected physical printer (step S116). In this case, the general-purpose printer driver 112 may transmit the print data to the printing apparatus 200, which is the selected physical printer.

Meanwhile, when the user selects the virtual printer (YES in S114), the information processing apparatus 100 displays the print setting screen (step S120). Specifically, the second display processing section 150 performs the second display processing to cause the print setting screen to be displayed on the display section 108a. As described above, the print setting screen is displayed by the print assist application 114. The print setting screen displays selectable individual virtual printers the user wants to use. The print setting screen displays items for which print settings other than the selection of the virtual printer can be made.

The information processing apparatus 100 selects a virtual printer used for printing (step S122). Specifically, the second display processing section 150 accepts an operation of the user to select the virtual printer on the print setting screen. Further, the information processing apparatus 100 accepts the print settings (step S124). Specifically, the second display processing section 150 accepts an operation of the user on the print setting screen other than the selection of the virtual printer.

The information processing apparatus 100 causes printing to be executed by using the selected virtual printer (step S128). Specifically, the print control section 160 transmits the print data to the printing apparatus 200 corresponding to the selected virtual printer, as described above.

### Example of Display Screen

Hereinafter, the description will be made with reference to examples of the display screen, together with Comparative Example.

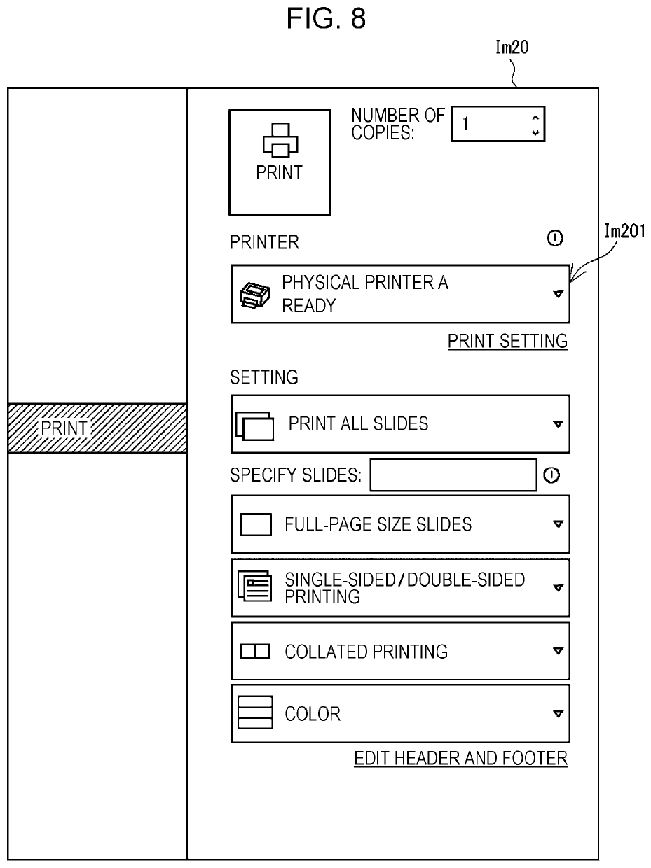

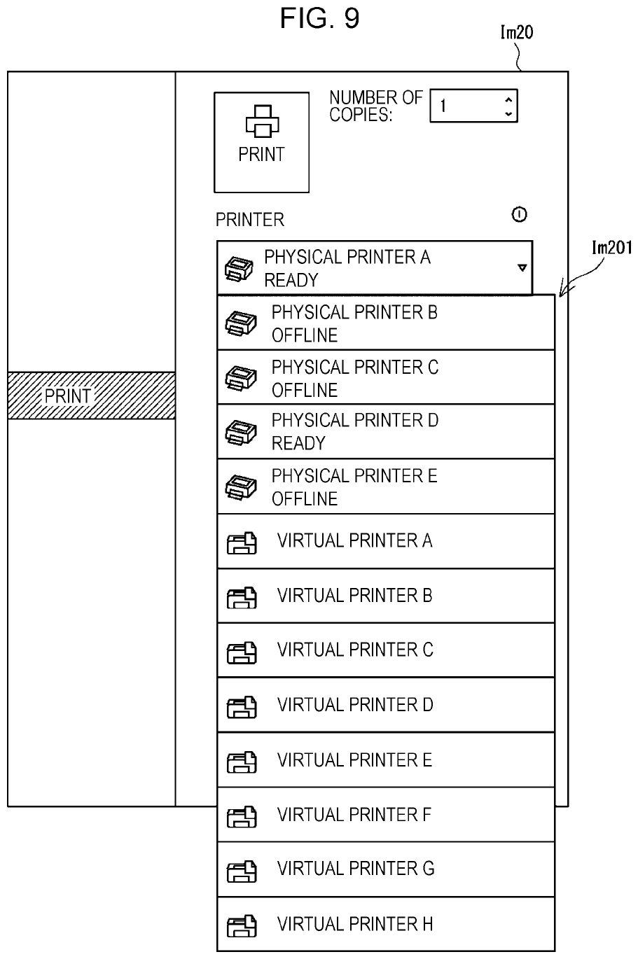

FIGS. 8 and 9 are views illustrating examples of a print setting screen Im20 according to Comparative Example. The print setting screen Im20 can be displayed by the application 116. In Comparative Example, when the user performs an operation of instructing the printing of the image data generated by the application 116, the print setting screen Im20 illustrated as an example in FIG. 8 is displayed. The print setting screen Im20 includes a printer selection screen Im201. The printer selection screen Im201 is configured by, for example, a pull-down menu.

When the user operates the printer selection screen Im201, as illustrated as an example in FIG. 9, a list of printers is displayed on the printer selection screen Im201. Here, in Comparative Example, the physical printers A, B, C, D, and E and the virtual printers A, B, C, D, E, F, G, and H are displayed on the printer selection screen Im201. Therefore, since the print queues of all the virtual printers are displayed on the printer selection screen Im201, the printer selection screen Im201 is complicated for the user.

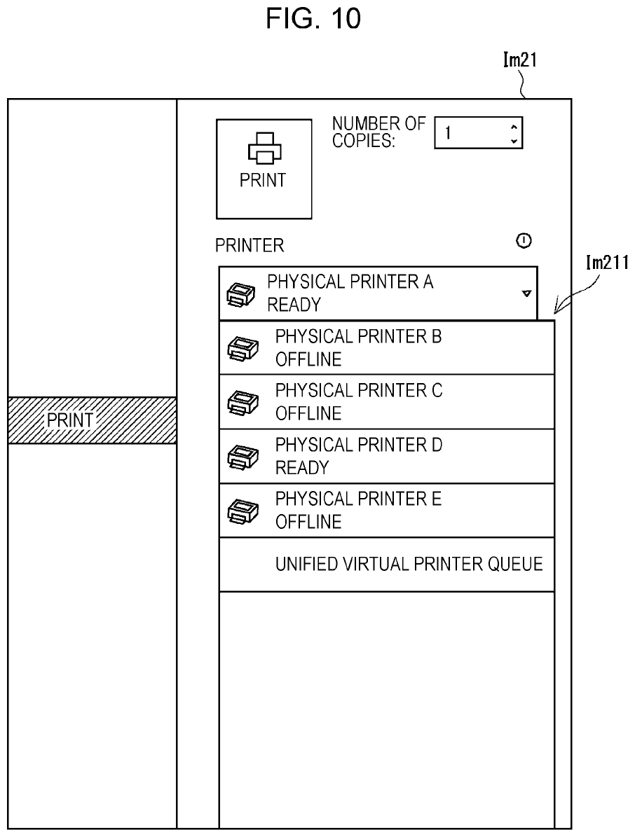

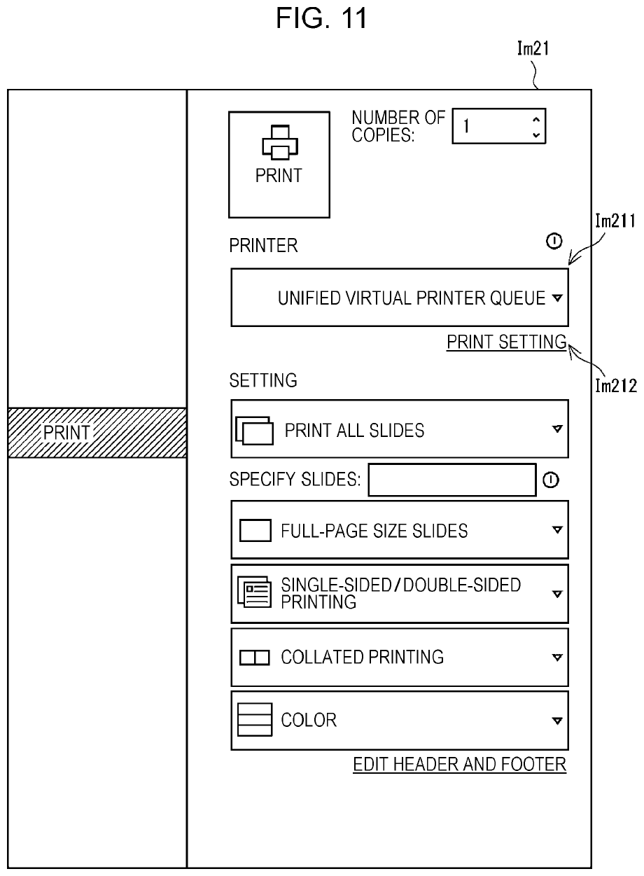

FIGS. 10 and 11 are views illustrating examples of a print setting screen Im21 according to Embodiment 1. The print setting screen Im21 can be displayed by the application 116. In Embodiment 1, when the user performs an operation of instructing the printing of the image data generated by the application 116, the print setting screen Im21 illustrated as an example in FIG. 10 is displayed. The print setting screen Im21 includes a printer selection screen Im211. The printer selection screen Im211 is configured by, for example, a pull-down menu.

When the user operates the printer selection screen Im211 displayed on the print setting screen Im21 according to Embodiment 1, as illustrated as an example in FIG. 10, a list of printers is displayed on the printer selection screen Im211. Here, in Embodiment 1, the physical printers A, B, C, D, and E and one unified virtual printer queue are displayed on the printer selection screen Im211 by the operation of the first display processing section 130. Therefore, the print queues for the virtual printer are displayed as one unified virtual printer queue on the printer selection screen Im211. Therefore, it is possible to suppress the complication when the user selects a printer. When the user wants to use the virtual printer, the user performs an operation of selecting the unified virtual printer queue displayed on the printer selection screen Im211. As a result, as illustrated in FIG. 11, the unified virtual printer queue is selected on the printer selection screen Im211.

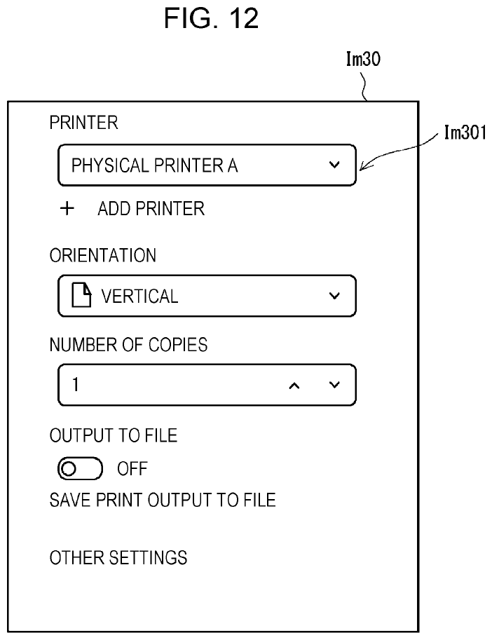

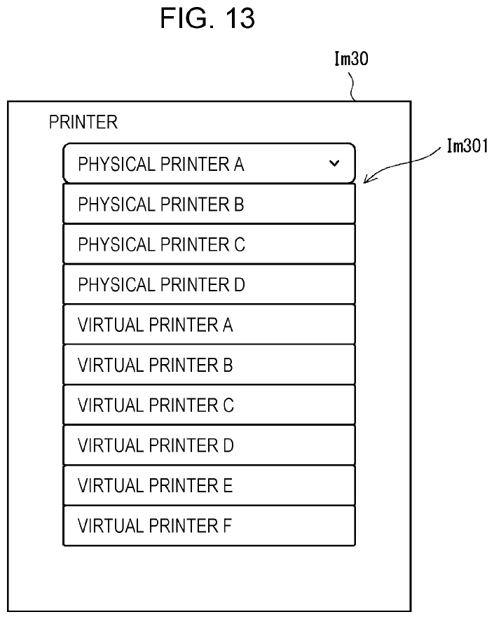

FIGS. 12 and 13 are views illustrating examples of a print setting screen Im30 according to comparative Example. The print setting screen Im30 can be displayed by the general-purpose printer driver 112. In Comparative Example, when the general-purpose printer driver 112 accepts the print instruction from the application 116, the print setting screen Im30 illustrated as an example in FIG. 12 is displayed by the OS standard printing function. The print setting screen Im30 includes a printer selection screen Im301. The printer selection screen Im301 is configured by, for example, a pull-down menu.

When the user operates the printer selection screen Im301, as illustrated as an example in FIG. 13, a list of printers is displayed on the printer selection screen Im301. Here, in Comparative Example, the physical printers A, B, C, and D and the virtual printers A, B, C, D, E, and F are displayed on the printer selection screen Im301. Therefore, since the print queues of all the virtual printers are displayed on the printer selection screen Im301, the printer selection screen Im301 is complicated for the user.

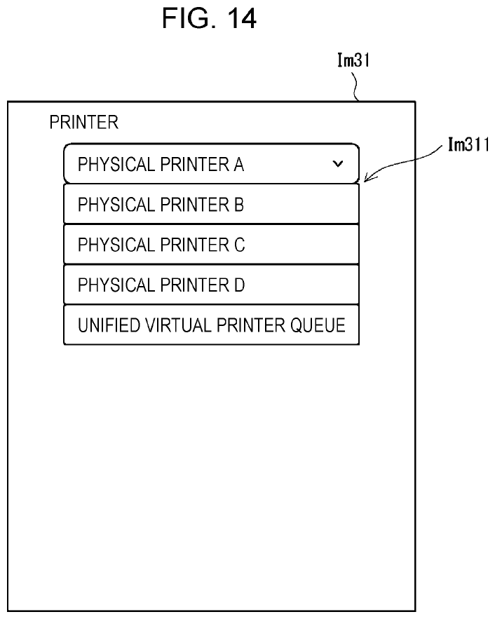

FIGS. 14 to 16 are views illustrating examples of a print setting screen Im31 according to Embodiment 1. The print setting screen Im31 can be displayed by the general-purpose printer driver 112. In Embodiment 1, when the general-purpose printer driver 112 accepts the print instruction from the application 116, the print setting screen Im31 illustrated as an example in FIG. 14 is displayed by the OS standard printing function. The print setting screen Im31 includes a printer selection screen Im311. The printer selection screen Im311 is configured by, for example, a pull-down menu.

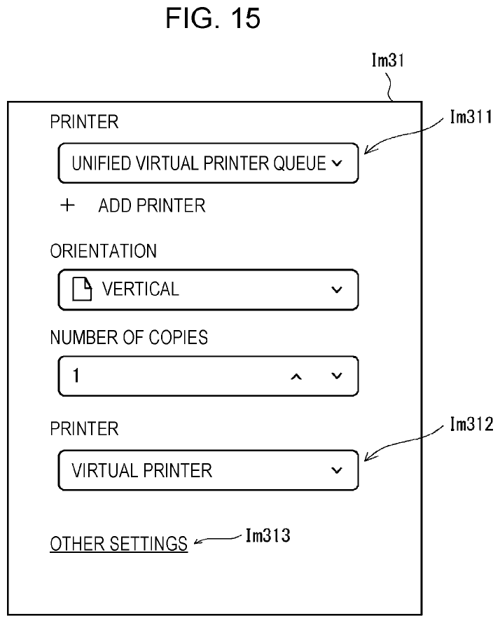

When the user operates the printer selection screen Im311 displayed on the print setting screen Im31 according to Embodiment 1, as illustrated in FIG. 14, a list of printers is displayed on the printer selection screen Im311. Here, in Embodiment 1, the physical printers A, B, C, and D and one unified virtual printer queue are displayed on the printer selection screen Im311 by the operation of the first display processing section 130. Therefore, the print queues for the virtual printer are displayed as one unified virtual printer queue on the printer selection screen Im311. Therefore, it is possible to suppress the complication when the user selects a printer. When the user wants to use the virtual printer, the user performs an operation of selecting the unified virtual printer queue displayed on the printer selection screen Im311. As a result, as illustrated in FIG. 15, the unified virtual printer queue is selected on the printer selection screen Im311.

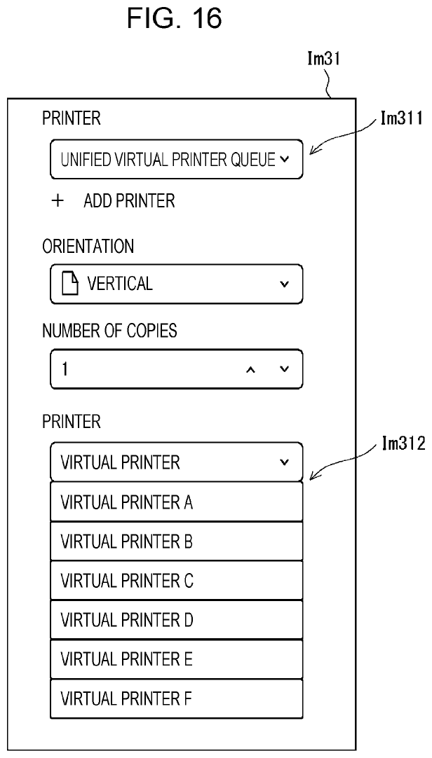

When the unified virtual printer queue is selected on the printer selection screen Im311, the second display processing section 150 causes a virtual printer selection screen Im312 for selecting a virtual printer, to be displayed on the print setting screen Im31. That is, the second display processing section 150 causes the print setting screen Im31 for displaying selectable virtual printers, to be displayed. The virtual printer selection screen Im312 is configured by, for example, a pull-down menu. When the user performs an operation on the virtual printer selection screen Im312 displayed on the print setting screen Im31 according to Embodiment 1, as illustrated as an example in FIG. 16, a list of the virtual printers registered in advance by the registration processing is displayed on the virtual printer selection screen Im312. In the example of FIG. 16, the virtual printers A, B, C, D, E, and F are displayed on the virtual printer selection screen Im312. Therefore, the user can select the virtual printer the user wants to use, by operating the virtual printer selection screen Im312.

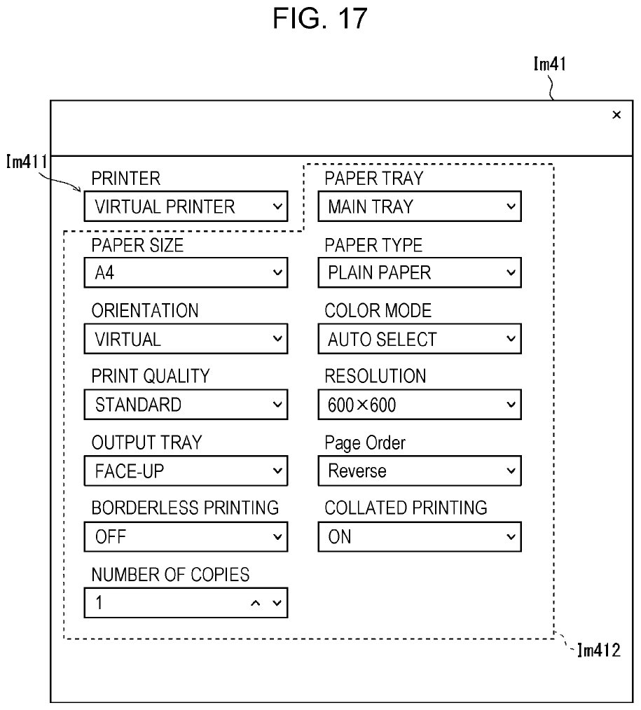

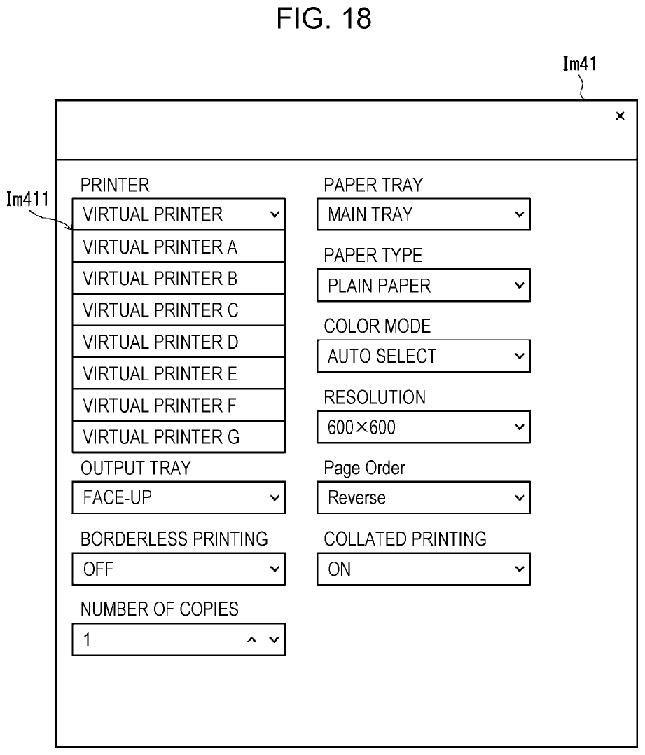

FIGS. 17 and 18 are views illustrating examples of a print setting screen Im41 according to Embodiment 1. The print setting screen Im41 can be displayed by the print assist application 114. The second display processing section 150 may cause the print setting screen Im41 to be displayed. The print setting screen Im41 may be displayed by, for example, the user operating the print setting screen Im21 illustrated as an example in FIG. 11 or the print setting screen Im31 illustrated as an example in FIG. 15. For example, the print setting screen Im41 may be displayed when the user performs a selection operation on a detailed setting screen display link Im212 in a state where the unified virtual printer queue is selected on the printer selection screen Im211 of the print setting screen Im21. For example, the print setting screen Im41 may be displayed when the user performs a selection operation on the detailed setting screen display link Im313 in a state where the unified virtual printer queue is selected on the printer selection screen Im311 of the print setting screen Im31.

The print setting screen Im41 displays a virtual printer selection screen Im411 for selecting a virtual printer and a print setting area Im412. The print setting area Im412 is an area for performing print settings other than the selection of the virtual printer. The virtual printer selection screen Im411 is configured by, for example, a pull-down menu. When the user operates the virtual printer selection screen Im411 displayed on the print setting screen Im41 according to Embodiment 1, as illustrated in FIG. 18, a list of the virtual printers registered by the registration processing is displayed on the virtual printer selection screen Im411. In the example of FIG. 18, the virtual printers A, B, C, D, E, F, and G are displayed on the virtual printer selection screen Im411. Therefore, the user can select the virtual printer the user wants to use, by operating the virtual printer selection screen Im411.

Further, when the user operates the virtual printer selection screen Im411, the virtual printer selection screen Im411 may display a list of virtual printers corresponding to the print settings set in the print setting area Im412. For example, it is assumed that the virtual printer G does not support printing of A3 size and the paper size is set to “A3” in the print setting area Im412. In this case, the virtual printer selection screen Im411 may not display the virtual printer G. Further, when the user selects the virtual printer on the virtual printer selection screen Im411, in the print setting area Im412, it may be configured such that print settings that cannot be configured with the selected virtual printer cannot be set. In the above example, when the user selects the virtual printer G on the virtual printer selection screen Im411, the paper size may not be set to “A3” in the print setting area Im412.

As described above, the information processing apparatus 100 according to Embodiment 1 executes the control program 120 that performs the following processing. When the print instruction is accepted from any application, the control program 120 executes the first display processing for displaying the selection screen for selecting any one printer of the virtual printer or the physical printer. Further, the control program 120 executes the second display processing for displaying the setting screen for performing print settings of the selected printer. Here, the first display processing displays a selection screen for displaying the plurality of virtual printers as a unified virtual printer queue which is one print queue. In addition, the second display processing causes the setting screen to be displayed in a state where one virtual printer used by the user can be selected from among the plurality of virtual printers. With such a configuration, even when a large number of virtual printers are registered in the print assist application 114, the user can easily select the print queue for the printer the user wants to use. Therefore, the user can efficiently set the print queue.

### Modification Example

The present disclosure is not limited to the above embodiments, and can be appropriately changed in a range without departing from the gist. For example, the order of each processing in the above-described flowchart can be appropriately changed. In addition, one or more processing in the flowchart described above may be omitted. For example, in the flowchart illustrated in FIG. 7, the order of the processing of S122 and the processing of S124 may be reversed. In addition, the processing of S122 and the processing of S124 may be executed in parallel with each other.

Further, the information processing apparatus 100 according to the above-described embodiment is configured such that, when displaying the list of printers, a plurality of virtual printers are displayed as one unified virtual printer queue. Further, when displaying the list of printers, the information processing apparatus 100 may display the plurality of physical printers as one unified print queue.

In the above-described example, a program includes a group of commands (or software codes) for causing a computer to perform one or more functions described in the embodiment when being read by the computer. The program may be stored in a non-transitory computer-readable medium or a physical storage medium. As a non-limiting example, the computer-readable medium or the storage medium having a physical entity includes a random-access memory (RAM), a read-only memory (ROM), a flash memory, a solid-state drive (SSD) or other memory technology, a CD-ROM, a digital versatile disk (DVD), a Blu-ray (registered trademark) disk, or other optical disk storage, a magnetic cassette, a magnetic tape, a magnetic disk storage, or other magnetic storage device. The program may be transmitted on a transitory computer-readable medium or a communication medium. As a non-limiting example, the transitory computer-readable medium or the communication medium includes electrical, optical, acoustic, or other forms of propagating signals. In addition, the program is included in a program product.

What is claimed is:

1. A non-transitory computer-readable storage medium storing a control program for extending a general-purpose printer driver, the control program causing a computer to execute:
first display processing for displaying a selection screen for selecting any one printer of a virtual printer or a physical printer, when a print instruction is accepted from any application; and
second display processing for displaying a setting screen for performing print settings of the selected printer, wherein
the first display processing causes the selection screen for displaying a plurality of virtual printers as a single print queue, to be displayed, and
the second display processing causes the setting screen to be displayed in a state where one virtual printer to be used by the user is selectable from among the plurality of virtual printers.

2. The non-transitory computer-readable storage medium storing a control program according to claim 1, wherein
the second display processing causes the setting screen for displaying print queues for the plurality of virtual printers, to be displayed when one print queue corresponding to a virtual printer is selected on the selection screen displayed by the first display processing.

3. The non-transitory computer-readable storage medium storing a control program according to claim 2, further causing the computer to execute registration processing for registering the plurality of virtual printers, wherein
the second display processing causes the setting screen for displaying the print queues for the plurality of virtual printers registered by the registration processing, to be displayed.

4. The non-transitory computer-readable storage medium storing a control program according to claim 1, wherein
the second display processing causes the setting screen for displaying the usable virtual printers in a selectable manner based on print settings other than the selection of the virtual printer, to be displayed.

5. The non-transitory computer-readable storage medium storing a control program according to claim 1, wherein
the second display processing causes the setting screen for displaying the usable virtual printers in a selectable manner based on a status of the physical printer corresponding to the virtual printer, to be displayed.

6. The non-transitory computer-readable storage medium storing a control program according to claim 1, wherein
the control program is a control program realized by a Print Support Application.

7. An information processing apparatus that executes a non-transitory computer-readable storage medium storing a control program for extending a general-purpose printer driver, the apparatus comprising:
a first display processing section configured to display a selection screen for selecting any one printer of a virtual printer or a physical printer, when a print instruction is accepted from any application; and
a second display processing section configured to display a setting screen for performing print settings of the selected printer, wherein
the first display processing section causes the selection screen for displaying a plurality of virtual printers as a single print queue, to be displayed, and
the second display processing section causes the setting screen to be displayed in a state where one virtual printer to be used by the user is selectable from among the plurality of virtual printers.

8. A control method for executing a non-transitory computer-readable storage medium storing a control program for extending a general-purpose printer driver, the method comprising:
first display processing for displaying a selection screen for selecting any one printer of a virtual printer or a physical printer, when a print instruction is accepted from any application; and
second display processing for displaying a setting screen for performing print settings of the selected printer, wherein
the first display processing causes the selection screen for displaying a plurality of virtual printers as a single print queue, to be displayed, and
the second display processing causes the setting screen to be displayed in a state where one virtual printer to be used by the user is selectable from among the plurality of virtual printers.
